(19) United States
(12) Patent Application Publication
(10) Pub. No.: US 2009/0075733 A1
(43) Pub. Date: Mar. 19, 2009

(54) INTERACTIVE PLAYMAT

(75) Inventors: Jacob Ranis Stokholm Andersen, Hong Kong (CN); Henrik Andersen, Kgs Lyngby (DK)

Correspondence Address: VOLPE AND KOENIG, P.C., UNITED PLAZA, SUITE 1600, 30 SOUTH 17TH STREET, PHILADELPHIA, PA, 19103, US

(73) Assignee: HOME FOCUS DEVELOPMENT LTD., Tortola (VG)

(21) Appl. No.: 12/235,168

(22) Filed: Sep. 22, 2008

Related U.S. Application Data
(63) Continuation of application No. PCT/IB2007/000750, filed on Mar. 22, 2007.
(60) Provisional application No. 60/784,699, filed on Mar. 22, 2006.

(51) Int. Cl. G06F 19/00; A63F 9/24; A63F 13/00

(52) U.S. Cl. 463/34; 463/16; 463/43

(57) ABSTRACT

An interactive playmat that projects an image of a playmat onto a flat surface is provided. The interactive playmat interactively provides instructions to the game players during play. Some embodiments of the virtual playmat can sense when an action is performed with respect to one of the game pieces on the virtual playmat, and can take into account the position and characteristics of the individual game pieces when formulating the instructions for each play cycle.

### CROSS REFERENCE TO RELATED APPLICATIONS

This application is a continuation of International Application No. PCT/IB2007/000750 filed Mar. 22, 2007, which claims priority to U.S. Provisional Application No. 60/784,699, filed Mar. 22, 2006, the contents of which are incorporated by reference as if fully set forth.

### FIELD OF INVENTION

The present invention relates to playing games. More specifically, the invention provides a virtual playmat that can be projected onto a flat surface and a means of interactively providing instruction to players as they manipulate game pieces on the playmat.

### BACKGROUND

Playmats used for various types of games, such as board games or card games, have traditionally been made of cardboard, textiles, or other materials, and they are usually not very portable. Many of the games utilizing such playmats are complex, having extensive sets of rules, game pieces with varying characteristics, multiple options that can be taken by a player taking a turn, and multiple possible outcomes based on the option selected. Traditional playmats do little to assist the players in keeping track of these rules, and in implementing various options selected by the players, thereby resulting in a slow pace of play.

Various devices for providing virtual surfaces such as keyboards or other virtual input devices have been proposed. For example, U.S. Pat. No. 6,281,878 to Montellese discloses an apparatus for inputting data. The apparatus includes a means of projecting a template, for example an image of a keyboard, onto a surface. A second light source, such as a laser, is projected over the template of the keyboard. When a user strikes “keys” on the keyboard template, light is reflected back towards a sensor. The height at which the reflected light is detected by the sensors, along with “binocular disparity” and triangulation algorithms, are used to determine the specific key that was struck. Similar devices are described in U.S. Patent Application Publication US 2004/0095315 of Montellese.

U.S. Pat. No. 6,650,318 to Arnon discloses a data input device that projects a template onto a surface. The device includes various sensors to determine when a user has struck a location defined within the template. The sensors can be acoustic sensors, in which case the system uses a triangulation algorithm to determine the location within the template that has been struck. The system can also include a light source combined with a pair of light sensors. The angle at which reflected light enters the light sensors can be compared to determine the location of the object reflecting the light from the template. The patent briefly discloses the use of the invention in conjunction with light-generated game objects such as a chess piece and chess board, without going into detail about how such a game could be played or providing interactive instruction for playing the game.

U.S. Pat. No. 6,611,252 to DuFaux discloses a virtual data input device that detects objects within an input zone (for example, fingers within an image of a keyboard), using light reflected off of the objects towards an optical detector. The device “optically interfaces” with an operator to detect the positions of objects within an input zone, to allow the operator to enter data into an associated computer. The positions of objects within the input zone correspond to a unique selection of data to be entered into the computer and the position and intensity of the reflected light is used to determine the position of the object within the input zone. A similar invention is disclosed in U.S. Pat. No. 6,798,401 to DuFaux.

U.S. Pat. No. 6,614,422 to Rafii discloses a system for entering data using a virtual input device. Reflected radiation is used to determine the three-dimensional position and velocity of a user's fingers during typing on a virtual keyboard. The actual shape of a user's fingers and position relative to other fingers can be detected and calculated to determine the position of a given finger.

U.S. Pat. No. 6,710,770 to Tomasi discloses the use of a pair of cameras to determine the location of a virtual input device that is touched. The device generates a fan beam to create a plane of light substantially parallel to and above a surface, such that penetration of this plane of light by an object is equivalent to touching a position on the surface. Active light sources can be used in conjunction with the cameras, and “passive triangulation” is used to determine the location at which the plane of light was touched.

U.S. Pat. No. 6,750,849 to Potkonen discloses a method of generating a virtual keyboard. A laser transmitter is used to project an image of a keyboard on a flat surface. This transmitter also functions as a light source which is reflected towards a sensor when an object touches a location on the virtual keyboard. The angle of incidence and time of arrival of the received signal are used to determine the selected key on the keyboard.

U.S. Pat. No. 6,955,297 to Grant discloses a surface scanning system for identifying a location on a template, and then performing an action based on indicia contained within that location. An image of the template surface is stored in the computer memory, and the system has means for identifying different parts of the surface from the stored memory when the user points to a specific part of the template. The most preferred embodiment is a template in the form of a book, with each page of the book being recognized by either a bar code, or by the words on each of the four corners of the page. A child learning how to read can point to a word. The system will identify the location (and thus the word) on the page where the child has pointed, and then pronounce the word.

U.S. Pat. No. 6,542,087 to Lin discloses a system for identifying a point of interest on an object located in front of a computer-controllable display area. The image of the display area is captured, and pixels associated with the object and with the display area boundary are identified by an intensity mapping function. A subset of pixels common to both the object and boundary can be identified. To determine which pixels are associated with the object, the measured light intensity is compared with the expected light intensity that each pixel would have if no object was present.

U.S. Pat. No. 6,791,531 to Johnston discloses a device and method for controlling a cursor. The device includes an infrared radiation source and imaging lens. The device finds the center of an object by determining the center of a group of pixels having illumination values above a certain threshold. Cursor control software is then used to move the cursor in a manner corresponding to the center of the object.

All of the above patents are limited to sensing an object within an input zone and then interpreting the sensed information to produce the desired output. None of these references teaches a specific means of utilizing such technology in the playing of the game. Additionally, none of these references teach a means of interactively providing instructions for the playing of a game as the game progresses, and based on the decisions of the players. Accordingly, there is a need for an interactive playmat that provides interactive instructions to the players, depending upon the choices they make during game play.

### SUMMARY

The invention is related to an interactive playmat for playing a game. The playmat includes an image projector that projects an image of a playmat on a surface and a device that provides instructions to at least one player for playing a game.

The invention is also related to a method of playing a game. The method includes projecting an image of a playmat on a surface; and interactively providing instructions to at least one player.

These features of the invention will become more apparent through the following description and drawings.

### BRIEF DESCRIPTION OF THE DRAWINGS

For the purpose of illustrating the invention, there is shown in the drawings a form which is presently preferred; it being understood, that this invention is not limited to the precise arrangements and instrumentalities shown.

FIG. 1 is an environmental, perspective view of an interactive playmat according to the present invention.

FIG. 2 is an environmental, perspective view of an interactive playmat according to the present invention, including details of one embodiment of a game piece.

FIG. 3 is an environmental, perspective view of another embodiment of an interactive playmat according to the present invention.

FIG. 4 is an environmental, perspective view of an alternative embodiment of an interactive playmat according to the present invention.

FIG. 5 is an environmental, perspective view of yet another alternative embodiment of an interactive playmat according to the present invention.

FIG. 6 is a flow chart illustrating a method of game play using an interactive playmat of the present invention.

FIG. 7 is an environmental, perspective view of yet another alternative embodiment of an interactive playmat according to the present invention.

FIG. 8 is an environmental, perspective view of yet another alternative embodiment of an interactive playmat according to the present invention.

Like reference characters denote like elements throughout the drawings.

### DETAILED DESCRIPTION OF THE PREFERRED EMBODIMENTS

### Introduction to the Embodiments

The invention provides an interactive playmat that projects an image of a playmat onto a surface, and which interactively provides instruction to the players.

For the purpose of this description, a playmat is defined as a template having a plurality of locations defined thereon upon which a player can place a game piece, or can otherwise act. A game is defined as any method of play using a playmat or other template, including but not limited to card games, board games, and play of a simulated musical instrument. A game piece is defined as any object that is manipulated by a player within the playmat in order to play a game, and can include a playing card, a game card representing a character, or an object that is moved around the playmat by a player, for example, a chess piece, a checker, a depiction of a character or vehicle, or other similar game piece. Interactive instructions are defined as instructions that are provided to a player on a step by step basis, taking into account not only the rules of the game, but also the present position and/or characteristics of the game pieces being brought into play and/or acted upon during the present play cycle, or, if no game pieces are present, the sequence of actions to be performed by the player to produce a desired result. Characteristics of game pieces can include patterns of movement to which the game pieces are limited, strength, life remaining within the character represented by the game piece, weapons or spells that can be utilized by the character represented by the game piece, or other capabilities of the character that must be taken into account during play of the game. These characteristics can or can not change as the game is played, and in some examples can be read from a game piece. As used herein, a play cycle is defined as at least one selection of one option by one player, and the resulting outcome, beginning when one player takes a turn, and ending after the results of that player's chosen action are determined.

The interactive playmat can, for example, provide instructions regarding which player can take a turn during the present play cycle. The instructions can include the options available to this player. Upon the player selecting one of these options, some embodiments of the interactive playmat can utilize an outcome generator to determine the outcome of the options selected, for example, a change in location of a game piece, changes in the characteristics of one or more game pieces, and/or removal of a game piece from the playmat. For the purpose of this description, an outcome generator is defined as any device which determines an outcome of an action chosen by a player. The outcome generator can be determinative, for example, when placing a certain game piece on a template with certain other game pieces present causes a specific result according to the rules of the game. Alternatively, the outcome generator can be random, in which case it randomly selects from a plurality of possible choices, with the outcome of the selection affecting game play. An example of a random outcome generator is a simulated set of dice.

Some embodiments of the interactive playmat can include a timer for timing a player in selecting an option, for example, timing a player considering a move in a chess game.

Other embodiments of the interactive playmat can remember one or more characteristics of one or more game pieces. As these characteristics change during game play, the interactive playmat will continue to remember the current characteristics of each game piece, keeping track of which ones gain or lose various capabilities (such as a monster acquiring a different weapon, or a pawn crossing the chessboard and becoming a queen). When a certain characteristic goes to zero, the interactive playmat can require removal of the game piece from the playmat.

The image of the playmat can change in some embodiments to indicate where a game piece can be moved at a specific time, which section of the playmat should be acted upon, or to represent different play environments, for example, a forest or a battlefield.

Some embodiments of the interactive playmat can sense when a game piece has been placed in a certain location on the playmat, for example, when a card representing a character has been placed in a location indicating that that card is being placed into play. Alternatively, a portion of the playmat, or all of the playmat, can be scanned to determine the location of game pieces. The initial characteristics of various game pieces can be read directly from these game pieces in certain embodiments.

Other embodiments of the interactive playmat can not rely on game pieces, but instead rely on sensing when a player act on certain sections of the playmat, for example, striking a designated location on the playmat with the player's finger. An example of such a playmat projects an image forming a template of a musical instrument. Striking the various controls of the musical instrument can be sensed, causing the interactive playmat to produce an appropriate sound. Some examples can provide interactive indications of the next location on the template to touch to play a desired song.

It will be appreciated that the following description is intended to refer to specific embodiments of the invention selected for illustration in the drawings and is not intended to define or limit the invention, other than in the appended claim.

The present invention provides an interactive playmat for playing games such as various card and board games, or for simulated play of a musical instrument.

### DETAILED DESCRIPTION

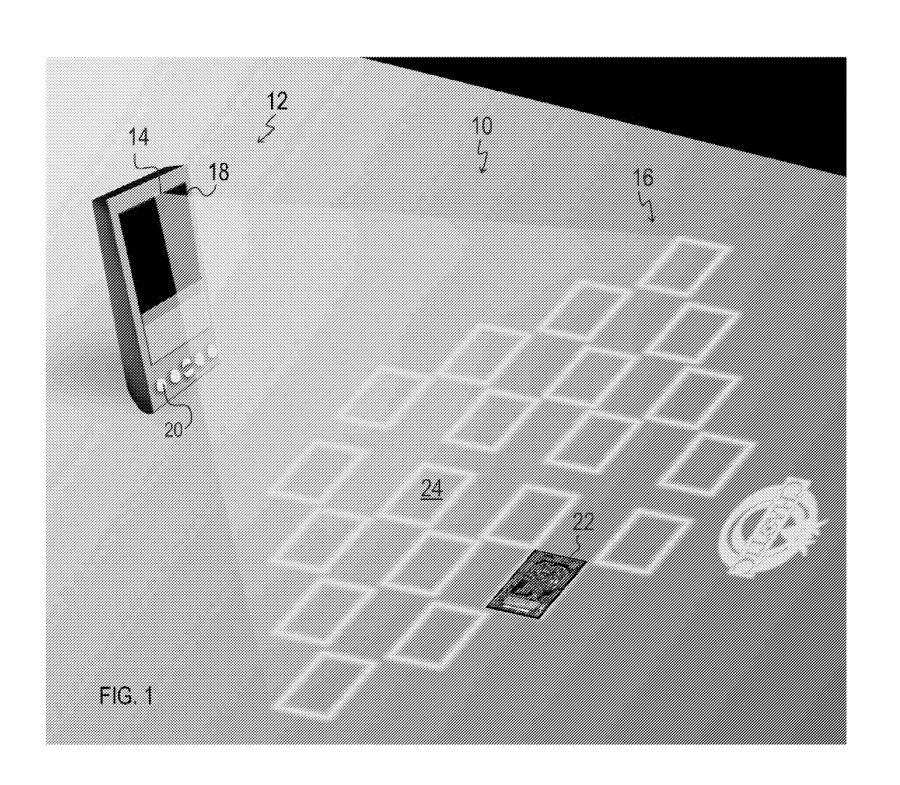

Referring to FIGS. 1-5, the interactive playmat 10 is illustrated. The interactive playmat 10 includes a game controller 12 having a projector 14 for projecting a template 16 that is an image of playmat. The game controller 12 can also include a display screen 18 for displaying various instructions, menu options, or other information to the players, and a plurality of controls 20.

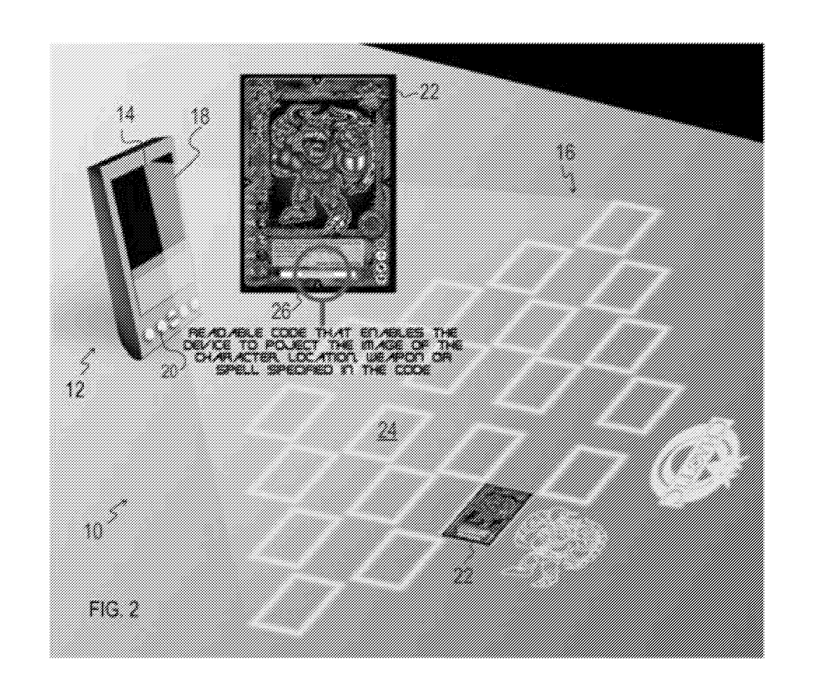

Some embodiments of the game controller 12 can also include a sensor for detecting/sensing the presence, position, characteristics, and/or orientation of a game piece 22 (for example, the card representing a monster character in FIGS. 1-2) within one of the game piece locations 24 defined within the template 16. A variety of different sensors can be utilized for this purpose. For example, a barcode scanner or other scanner for scanning readable code such as the readable code 26 shown in FIG. 2 can be used to scan the game piece locations 24, sensing the presence of a game piece 22 when readable code 26 is read. The readable code 26 can also contain various characteristics of the game piece 22, for example, the name of the character represented, patterns of movement to which the game piece 22 is limited, weapons or spells that can be used by the character represented by the game piece 22, or other characteristics of the game piece 22. As another alternative, a system of associating pixels with an object within a display area is disclosed within U.S. Pat. No. 6,542,087, the entire disclosure of which is expressly incorporated herein by reference. The presence of a game piece 22 within a location 24 would change the intensity of light received by pixels representing that location in a reflected image. If a three-dimensional game piece 22 is used, methods disclosed in U.S. Pat. Nos. 6,281,878; 6,955,297; 6,650,318; 6,611,252; 6,798,401; 6,614,422; 6,710,770; 6,750,849; and Published Application No. 2004/0095315; for all of which the entire disclosures are expressly incorporated herein by reference, can be used to detect the presence of a game piece 22 in a location 24. As yet another alternative, if the location of a game piece 22 is not critical, then the characteristics of a game piece 22 can simply be read, for example, by holding the game piece 22 under a bar code reader that is built into the game controller 12, or by plugging the game piece 22 into a suitable receptacle defined within the game controller 12, and having a reader for reading information from a game piece 22 therein.

The game controller 12 can further include a detector for detecting when the template 16, or a game piece 22 located within the template 16, is acted upon. Examples include touching a location 24 within the template 16, possibly a location 24 containing a game piece 22 which a player would like to bring into play during the current play cycle. U.S. Pat. Nos. 6,281,878; 6,955,297; 6,650,318; 6,611,252; 6,798,401; 6,614,422; 6,710,770; 6,750,849; and Published Application No. 2004/0095315 disclose suitable sensors/detectors by which such an action on the part of the player can be sensed.

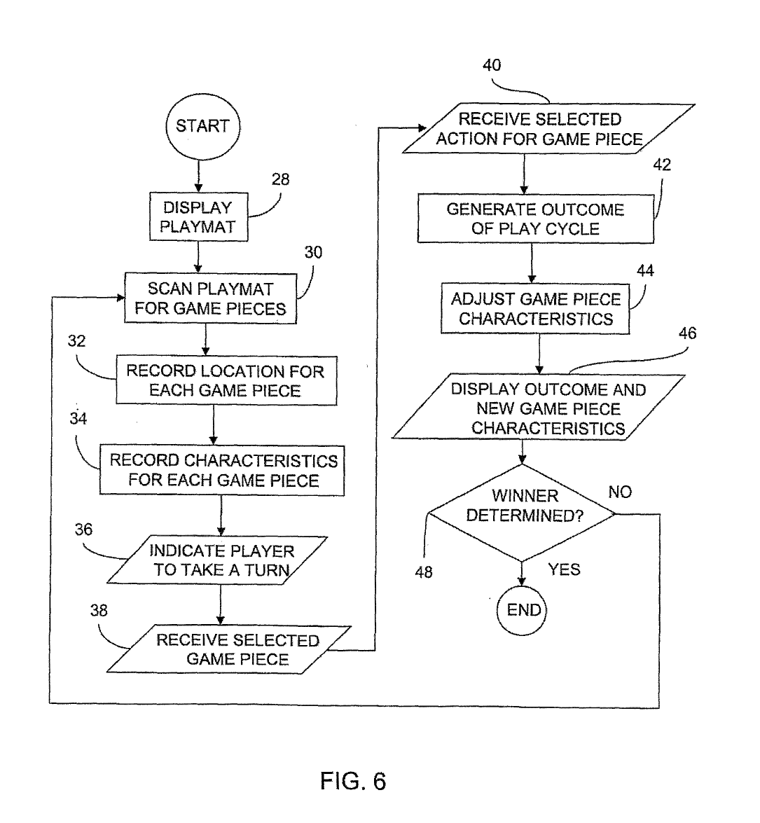

Referring to FIGS. 1-2 and 6, an example of a card game is illustrated. After the template 16 is displayed at step 28, a pair of opposing players can place a plurality of game pieces 22, representing various characters which will battle each other, within locations 24. The locations 24 containing game pieces 22 is next input into the game controller 12, possibly by the interactive playmat scanning the template 16 and sensing the location of game pieces 22. Alternative embodiments can utilize the controls 20 to permit the players to input the locations of the game pieces 22. Either function occurs at step 30 within FIG. 6. The location of each game piece 22, and the characteristics of each game piece 22, can be recorded by the game controller 12 at steps 32 and 34, respectively. Although the illustrated example records both the location and characteristics of each game piece 22, some examples of games can only require only the location, or only the characteristics, of a game piece to be read, and either alternative is within the scope of the invention.

The game controller 12 next indicates which player can take a turn, possibly using either the display screen 18, or projecting the information onto the template 16, at step 36. The player can select a specific game piece 22 or multiple game pieces 22, to be brought into play, possibly by touching the game pieces 22, or by utilizing the controls 20 on the game controller 12. The player next indicates the selected action for each game piece, for example, the attack to be carried out, the weapon or spell to be used, or the opposing player's game piece 22 to attack, at step 40. For each action selected by the player, the game controller 12 will randomly generate an outcome, which can take the form of a change in the characteristics of various game pieces 22 and/or the elimination of various game pieces 22 from the template 16 at step 42. The characteristics of the various game pieces 22 are adjusted using either predetermined or random criteria based on the outcome at step 44, with the outcome and new game piece characteristics being displayed at step 46. If the winner has been determined at step 48, the game will end. Otherwise, the game controller 12 with a return to step 30, receiving the locations of the game pieces 22 if they are not already known to the game controller 12, and then continuing with the next play cycle.

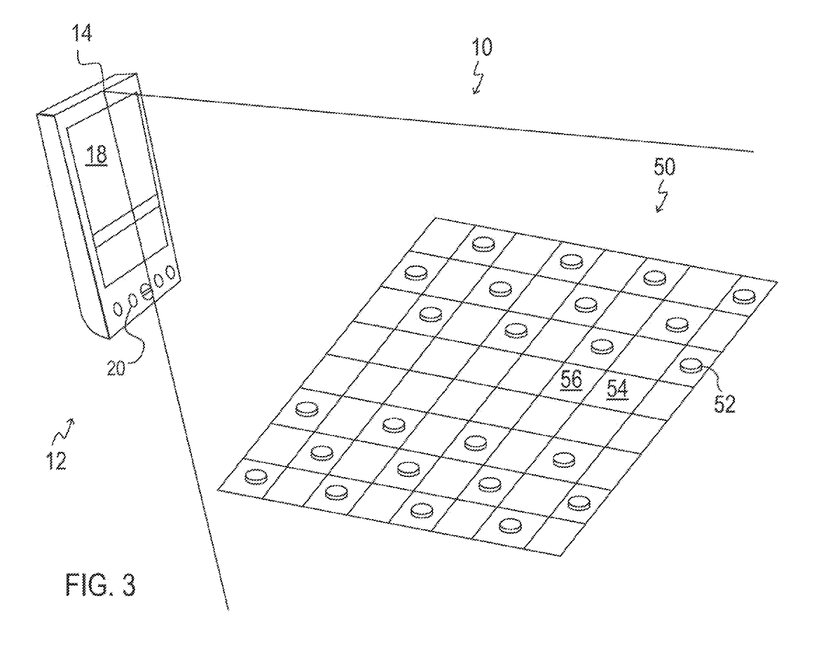

Referring to FIG. 3, the interactive playmat 10 is illustrated, with the game controller 12 displaying a template 50 in the form of a checker or chess board. The illustrated game pieces 52 are checkers, which in the illustrated example can be moved to any of the locations 54, but must remain outside of the locations 56. Although the illustrated example shows checkers, similar embodiments can be utilized to play chess, backgammon, or other similar games. Some examples of the game controller 12 can include the ability to compete against a single player, in the same manner as presently available computer chess games.

The game controller 12 can scan the template 50, determining the location of all of the game pieces 52. The game controller 12 will next indicate which player can take a turn. The game controller 12 can sense when a player has reached into the area of the template 50 using any of the methods disclosed within U.S. Pat. Nos. 6,281,878; 6,955,297; 6,650,318; 6,611,252; 6,798,401; 6,614,422; 6,710,770; 6,750,849; and Published Application No. 2004/0095315. Upon sensing an action by a player, the game controller 12 can scan the template 50 to determine the new locations of the game pieces 52. If a piece 52 has changed location, the game controller 12 can check to see if the new location of the piece 52 is in an acceptable location 54, or an unacceptable location 56. The game controller 52 can then indicate that the opposing player can take a turn, or that the player has made an illegal move and must make an alternative legal move. If one of the game pieces 52 reaches the opposing side of the template 50, the game controller 12 will change the characteristics of the game piece 52 recognizing the game piece 52 as a king.

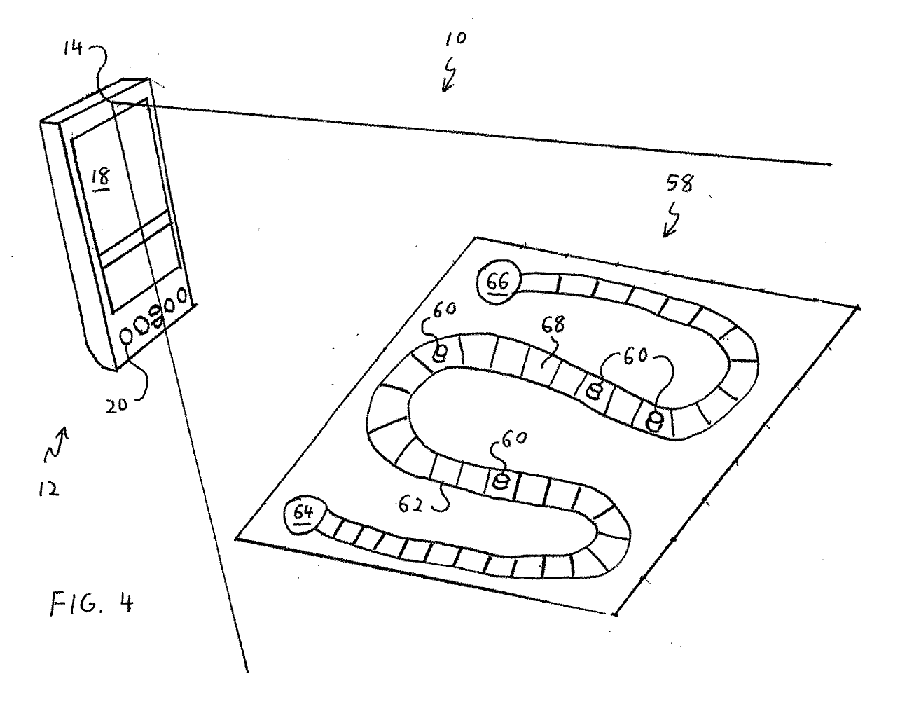

Referring to FIG. 4, an alternative template 58 is illustrated. A template 58 can be any of several board games wherein players attempt to race game pieces 60 along a path 62 from a starting position 64 to an ending position 66. A number of squares 68 that a player can move a game piece 60 during that player's turn is typically determined by some type of random selection, which is traditionally a spinner, dice, etc. The game controller 12 of the present invention can indicate which player can take a turn and upon the actuation of a control 20, generate a random number representing a number of squares 68 that the player can move that player's game piece 60. Some embodiments of the game controller 12 can scan the template 58, ensuring that the game pieces 60 are in a proper location, before indicating that the next player can take a turn.

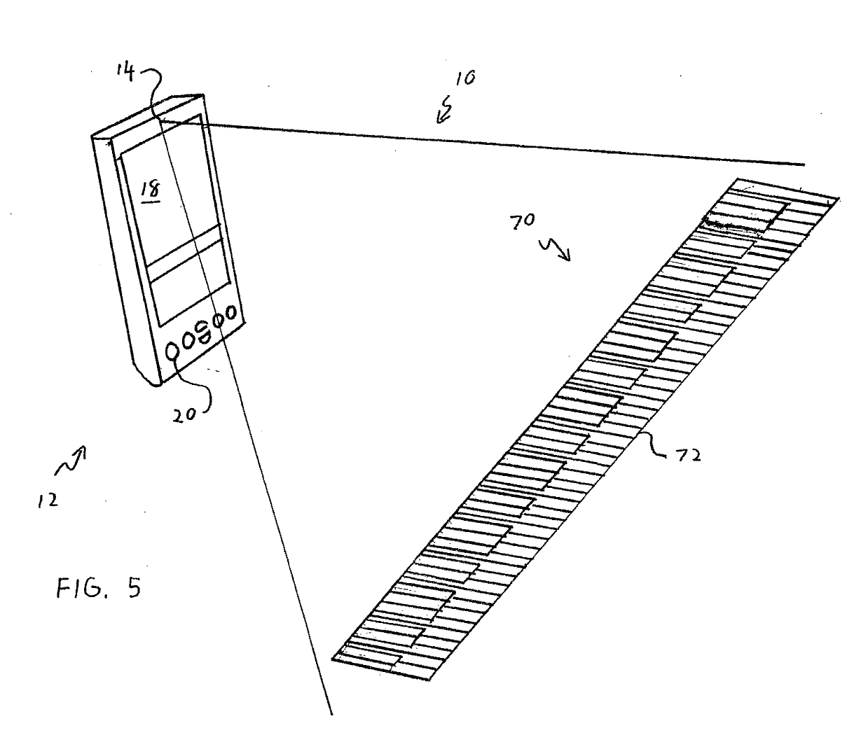

FIG. 5 illustrates yet another alternative template 70 projected by the game controller 12. The template 70 includes a plurality of designated locations 72 denoting the controls of a musical instrument, for example, the keys of a piano or organ, or various drums within a drum set. Some embodiments of the game controller 12 can alter the template 70 to indicate which of the keys 72 should be struck by a player's finger, for example, by lighting one of the keys 72. The note represented by the keys 72 can simultaneously, or alternatively, be displayed within the template 70. The action of a finger striking one of the keys 72 can be sensed as disclosed in U.S. Pat. Nos. 6,281,878; 6,955,297; 6,650,318; 6,611,252; 6,798,401; 6,614,422; 6,710,770; 6,750,849; and Published Application No. 2004/0095315. Upon sensing a finger striking a key 72, the game controller 12 can emit a sound corresponding to the musical note that would be emitted by a musical instrument.

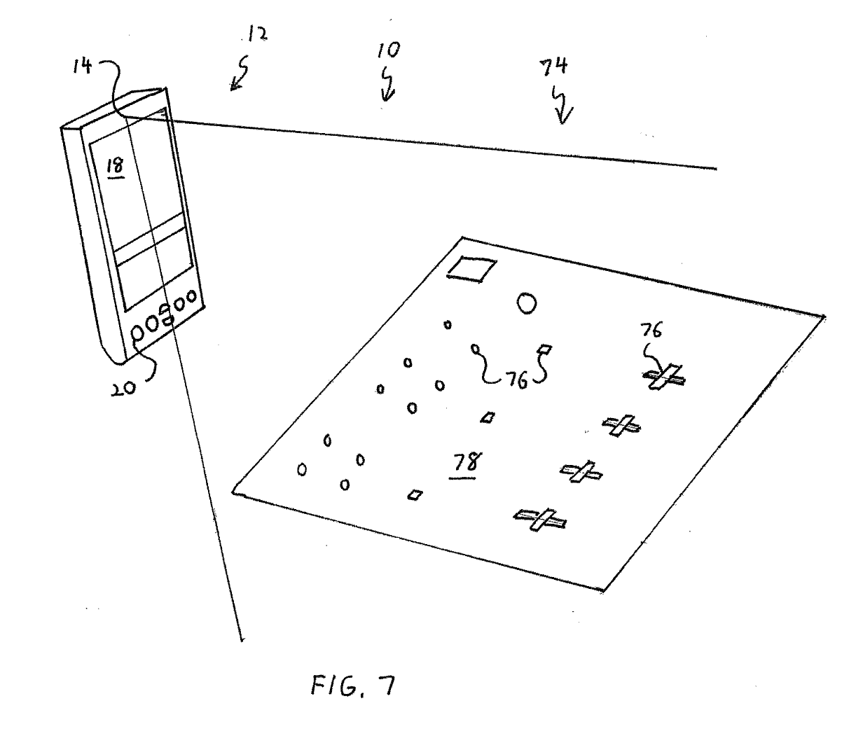

FIG. 7 shows a template 74 similar to the template 70 of FIG. 5. The template 74 denotes various controls 76 of a mixer 78, as a disk jockey might use. Touching the various controls 76 permits a user to speed up, slow down, reverse, or mix together various songs, in a manner well-known in the art of sound mixing. Some examples can store various songs in MP3 or other suitable format, or can communicate with various presently available MP3 players, CD players, or other sources of prepurchased music. Some examples can include an image of a record player, permitting a user to simulate scratching a record. The action of a finger striking, or moving along, one of the controls 76 can be sensed as disclosed in U.S. Pat. Nos. 6,281,878; 6,955,297; 6,650,318; 6,611,252; 6,798,401; 6,614,422; 6,710,770; 6,750,849; and Published Application No. 2004/0095315.

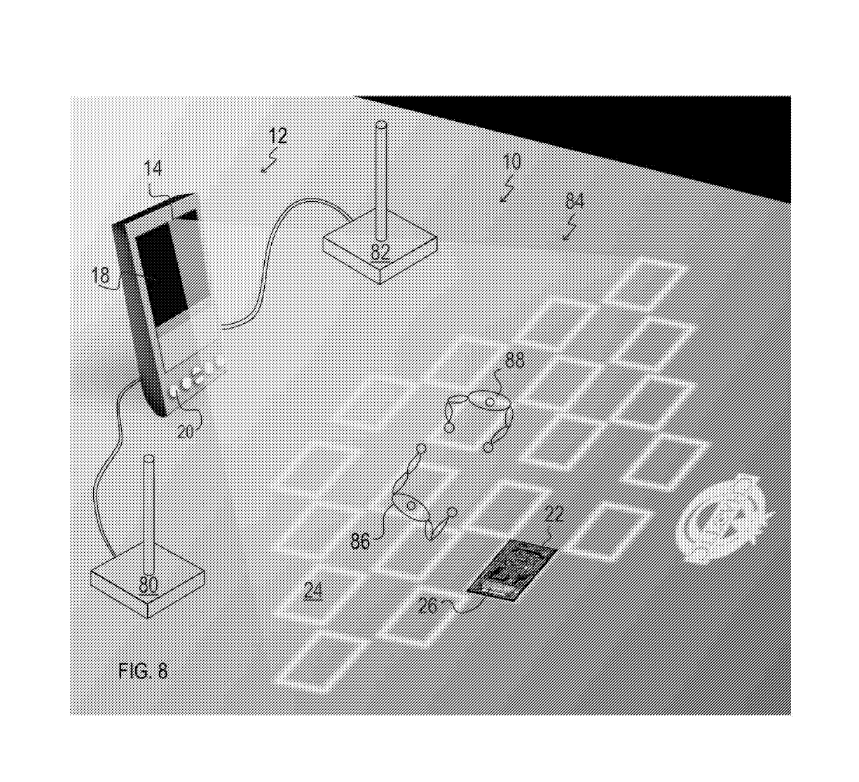

An alternative method of playing a game using a virtual playmat 10 is illustrated in FIG. 8. The virtual playmat 10 in FIG. 8 includes a pair of joysticks 80, 82 connected to the game controller 12. The template 84 in the illustrated example not only includes a location 24 for placing a game piece 22, but also includes an image 86, 88 of a character represented by the game piece 22. A pair of players can use the joysticks 80, 82 to control the characters 86, 88, respectively. Some examples can read a readable code 26 from a game piece 22, thereby obtaining the various characteristics of the character represented by the game piece 22. These characteristics can then be given to the characters 86, 88 that are projected onto the template 84. Each player can then control a character 86, 88 as the characters 86, 88 duel each other within the template 84, with the movement and actions of each projected character 86, 88 corresponding to the signals received from the joystick 80, 82 respectively. Controlling the movement of a video game character through the use of a joystick is well-known in the art. Other alternative game controllers 12 can interact with keyboards, mobile phones, personal digital assistants, or other similar devices to control the characters 86, 88, or other aspects of a game.

The number of games that can be played using the virtual playmat 10 can be increased in some examples of the virtual playmat 10 by providing the ability to download games from the Internet or from a central database, or by purchasing additional game “cartridges” which can be placed in communication with the virtual playmat 10. In other examples, additional characteristics of a game piece 22 can be downloaded to the game controller 12. For example, in a game of football (American or European), the characteristics of a game piece 22 representing a football player can be read from the game piece 22, and then the latest statistics for the player represented by the game piece 22 can be downloaded from the Internet, and used to affect the course of play. Some examples of a virtual playmat 10 can move a football around the template according to the results of each play.

Yet another example of the virtual playmat 10 can interact with a presently available video game controller by connecting to the same connections that would normally be used to connect the present video game controller to a television or monitor. The playmat would thereby permit playing the game using a virtual image projected onto a floor, wall, table, or other suitable surface. Such a video game can include the ability to alter the characteristics of the characters represented in the video game, in some examples by a second connection to a port defined within the video game controller for receiving a presently available game cartridge. The controller 12 would thereby interact with the presently available video game controller 12 by not only providing an alternative to a monitor, but also by providing input in the playing of the game in a manner similar to a presently available game cartridge, but with greater functionality.

While a specific embodiment of the invention has been described in detail, it will be appreciated by those skilled in the art that various modifications and alternatives to those details could be developed in light of the overall teachings of the disclosure. For example, multi-color templates and possibly three dimensional templates can be projected by the game controller. Accordingly, the particular arrangements disclosed are meant to be illustrative only and not limiting as to the scope of the invention which is to be given the full breadth of the appended claims and any and all equivalents thereof.

What is claimed is:

1. An interactive playmat for playing a game, the playmat comprising an image projector that projects an image of a playmat on a surface and a device that provides instructions to at least one player for playing a game.

2. The interactive playmat according to claim 1, wherein the instructions include instructions regarding which player can take a turn and available options to the player who can take a turn.

3. The interactive playmat according to claim 1, further comprising an outcome generator for determining an outcome of a play cycle, wherein the outcome generator is determinative or random.

4. The interactive playmat according to claim 1, further comprising a storage device that maintains a record of at least one characteristic of at least one game piece.

5. The interactive playmat according to claim 4, further comprising a controller configured to change the record of at least one characteristic of at least one game piece as game play progresses.

6. The interactive playmat according to claim 1, further comprising a controller configured to change the image of the playmat as a game progresses.

7. The interactive playmat according to claim 6, wherein the image of the playmat is changed to indicate the locations on the image of the playmat where the player who can take a turn can place a game piece.

8. The interactive playmat according to claim 1, further comprising a sensor configured to detect a game piece within at least one location defined on the image of the playmat.

9. The interactive playmat according to claim 8, wherein the sensor is configured to detect at least one characteristic of a game piece within at least one location defined on the image of the playmat.

10. The interactive playmat according to claim 1, further comprising a sensor configured to detect a location of at least one game piece within the image of the playmat.

11. The interactive playmat according to claim 10, further comprising a storage device in communication with the sensor that records at least one characteristic, detected by the sensor, of the at least one game piece.

12. The interactive playmat according to claim 11, further comprising a random outcome generator for determining an outcome of a play cycle.

13. The interactive playmat according to claim 4, further comprising a controller configured to change the record of at least one characteristic of at least one game piece based on an outcome of a play cycle.

14. The interactive playmat according to claim 10, further comprising an input configured to receive a selection of at least one game piece to be brought into play by a player.

15. The interactive playmat according to claim 14, further comprising an input configured to receive a selected action for the at least one game piece to be brought into play.

16. A method of playing a game, the method comprising: projecting an image of a playmat on a surface; and interactively providing instructions to at least one player.

17. The method of play according to claim 16, wherein providing instructions includes providing instructions about which player can take a turn and about the available options to the player who can take a turn.

18. The method of play according to claim 16, further comprising determining an outcome of a play cycle, wherein the outcome is determined determinatively or randomly.

19. The method of play according to claim 16, further comprising timing a play cycle.

20. The method of play according to claim 16, further comprising recording at least one characteristic of at least one game piece.

21. The method of play according to claim 16, further comprising changing the record of at least one game piece as game play progresses.

22. The method of play according to claim 16, further comprising changing the image of the playmat as game play progresses.

23. The method of play according to claim 22, further comprising changing the image of the playmat to indicate the locations on the image of the playmat where a player who can take a turn can place a game piece.

24. The method of play according to claim 16, further comprising sensing a game piece within at least one location defined on the image of the playmat.

25. The method of play according to claim 24, further comprising sensing at least one characteristic of a game piece within at least one location defined on the image of the playmat.

26. The method of play according to claim 16, further comprising sensing a location of at least one game piece within the image of the playmat.

27. The method of play according to claim 26, further comprising sensing and recording at least one characteristic of the at least one game piece.

28. The method of play according to claim 20, further comprising changing the record of at least one characteristic of at least one game piece based on the outcome of a play cycle.

29. The method of play according to claim 25, further comprising receiving a selection of at least one game piece to be brought into play by a player and receiving a selected action for the at least one game piece to be brought into play

30. The method of play according to claim 16, further comprising sensing an object striking a location defined within the image of the play mat; and generating a sound in response to an object striking a location defined within the image of the playmat, with a different sound being associated with each location defined within the image of the playmat.

31. The method of play according to claim 30, wherein the instructions include instructions about which location within the image of the playmat to strike.

32. The method of play according to claim 31, further comprising changing the image of the playmat to indicate the location within the image of the playmat that a user should strike.
